(19) United States
(12) Patent Application Publication
(10) Pub. No.: US 2020/0069045 A1
(43) Pub. Date: Mar. 5, 2020

(54) Mountable Table

(71) Applicant: Ronald H. Barwick, Oxford, FL (US)

(72) Inventor: Ronald H. Barwick, Oxford, FL (US)

(21) Appl. No.: 16/679,517

(22) Filed: Nov. 11, 2019

Related U.S. Application Data
(63) Continuation-in-part of application No. 15/948,225, filed on Apr. 9, 2018.
(60) Provisional application No. 62/533,988, filed on Jul. 18, 2017.

(51) Int. Cl. A47B 5/02; A47B 5/04; F16M 13/02

(52) U.S. Cl. CPC A47B 5/02; F16B 47/00; F16M 13/022; A47B 5/04

(57) ABSTRACT

A mountable table. The mountable table provides a stable and level surface for recreation enthusiasts to removably attach to a vehicle, such as a watercraft. A board is connected by first fasteners, which are connected by hinges to the first end of the board. The mountable table is rotatably adjustable by action of the hinges. The mountable table supports food or beverage containers when placed into a deployed position.

### CROSS REFERENCE TO RELATED APPLICATIONS

This application is a continuation-in-part and claims the benefit of U.S. Non-Provisional application Ser. No. 15/948,225 filed on Apr. 9, 2018, which claims the benefit of U.S. Provisional Application No. 62/533,988 filed on Jul. 18, 2017. The above identified patent applications are herein incorporated by reference in its entirety to provide continuity of disclosure.

### BACKGROUND OF THE INVENTION

The present invention relates to a mountable table. Many people enjoy recreational activities. Furthermore, some people may enjoy relaxing with a food or beverage item while engaging in recreational activities. However, many people prefer to place their food or beverages onto a flat surface while engaging in these recreational activities.

Current recreational tables do disclose a surface wherein people can place food and beverages; however, these devices do not provide users with the ability to quickly and easily remove the mountable table. By solving this problem, recreation enthusiasts will more easily be able to consume foods and beverages in the area surrounding their vehicle or watercraft.

### SUMMARY OF THE INVENTION

In view of the foregoing disadvantages inherent in the known types of tables now present in the known art, the present invention provides a mountable table that can be deployed for use by individuals engaging in outdoor recreational activities that is easily foldable.

The present system comprises a board having a first end and a second end. The first end is hingedly affixed to at least one first fastener. The first fastener is configured to removably secure the board to a support wall. A support leg is hingedly affixed to a bottom surface of the board opposite the support wall. The support leg has a second fastener disposed on an end thereof, opposite the board.

One object of the present invention is to provide a board wherein the board defines a plurality of recesses configured to receive a plurality of food or beverage containers. In one embodiment, the first fasteners and the second fasteners are suction cups, configured to secure the mountable table to the side of a vehicle or a watercraft.

Another object of the present invention is where the mountable table is adapted to be rotatably adjustable via the hinges when in a deployed position. The plurality of hinges operably connects the first fasteners to the board and are configured to enable a user to rotatably adjust the angle at which the board extends from the vehicle or the watercraft by a simple push towards the vehicle or watercraft or pull away from the vehicle or watercraft upon the second end of the board respectively.

In an additional embodiment of the invention, the board is lined on each of a plurality of sides by a bumper.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the mountable table.

FIG. 2 shows a top-down view of an embodiment of the mountable table.

FIG. 3 shows a side view of an embodiment of the mountable table in the deployed position.

### DETAILED DESCRIPTION OF THE INVENTION

Reference is made herein to the attached drawings. Like reference numerals are used throughout the drawings to depict like or similar elements of the mountable table. The figures are intended for representative purposes only and should not be considered to be limiting in any respect.

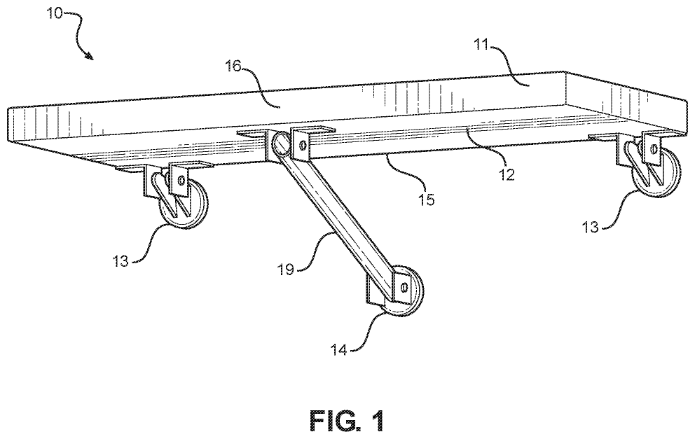

Referring now to FIG. 1, there is shown a perspective view of an embodiment of the mountable table. The mountable table 10 comprises a board 11. The board 11 is defined by a first end 15 and a second end 16, as well as an upper surface that is oriented oppositely a lower surface 12. The first end 15 is hingedly affixed to at least one first fastener 13. The first fastener 13 is configured to removably secure the board 11 to a support wall. In the illustrated embodiment, a pair of first fasteners 13 are hingedly affixed to the lower surface 12 of the board 11.

A support leg 19 is hingedly affixed to the lower surface of the board 11 in a position distal to the first fasteners 13 relative to the support wall. In the illustrated embodiment, the support leg 19 is an elongated rigid member centrally disposed between a pair of sides of the board 11. A second fastener 14 is disposed on an end of the support member 19 opposite the board 11. The second fastener 14 is configured to secure the position of the support member 19, such that the support member 19 acts as a brace for the board 11, providing cantilever support thereto. In the illustrated embodiment, the second fastener 14 is pivotally affixed to the support leg 19, such that the support leg 19 can be secured to a support wall at various angles respective thereto. In an alternate embodiment, the support leg 19 may be telescopic.

The board 11 is made of a material adapted to frictionally support a plurality of objects on the upper surface 12 thereof. In one embodiment, the upper surface 12 comprises a gripping surface adapted to provide an increased friction coefficient wherein the plurality of objects may be more effectively secured thereon. In some embodiments, the gripping surface comprises a textured surface, such that the surface area of the upper surface 12 in contact with an object is increased.

The second fasteners and first fasteners 14, 13 are a plurality of fasteners adapted to secure the mountable table 10 to a sidewall of a vehicle or a watercraft (not shown). In this way, the mountable table 10 extends outward therefrom, and is configured to be support food and beverage containers thereon and be accessible outside the confines of the vehicle or the watercraft.

In some embodiments, the first and second fasteners 13, 14 comprise suction cups configured to removably secure to the support wall. In a further embodiment, the first and second fasteners 13, 14 comprise suction cups controllable by actuation of a lever disposed thereon. Under this embodiment, each suction cup is operably connected to a lever wherein the lever is configured to break a vacuum seal produced through a suction of the suction cup upon actuation of the lever. In this way, the suction cups can utilize greater fastening force, thereby ensuring that the mountable table 10 remains in a desired position on the support wall.

The first fasteners 13 are attached by a plurality of hinges to the board 11. The hinges are adapted to enable a user to manipulate the board 11 such that the board 11 is rotatably adjustable. As such, the angle at which the board 11 extends from the vehicle or the watercraft is adjustable by the user. The hinges are of any suitable shape and configuration for enabling movement of the board 11 when the board 11 is in a deployed position.

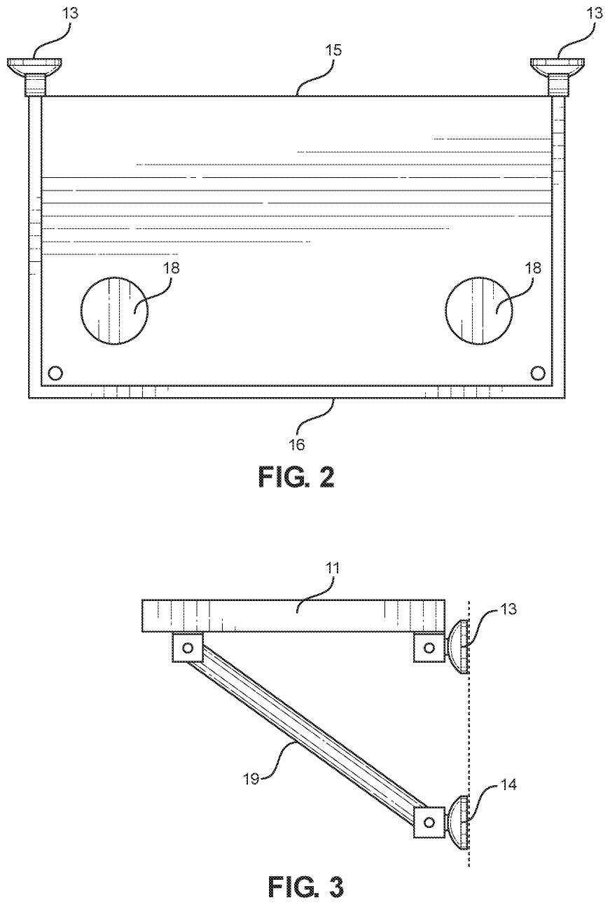

Referring now to FIG. 2, there is shown a top down view of the mountable table. In another embodiment, there are a plurality of recesses 18 defined in the upper surface 12. Each recess 18 of the plurality of recesses 18 is configured to removably secure a container such as a beverage container or a food container. In one embodiment, the recess 18 has an open lower end. In another embodiment, the recess has a base configured to provide structural support. Optionally, the mountable table may further comprise a plurality of flat inserts configured to rest in the plurality of recesses 18. Further in the shown embodiment, the board 11 has a plurality of bumpers attached to a plurality of sides of the board 11.

Referring now to FIG. 3, there is shown a side view of the mountable table. The mountable table is shown in a deployed position. While in a deployed position, as illustrated, the board 11 is resting perpendicularly relative to a side of the vehicle or watercraft to which the mountable table is attached. The deployed position is configured to enable the user to rest the plurality of objects on the upper surface of the board 11.

The positioning of the second fastener 14 upon the support wall determines the angle at which the board 11 extends from the first fastener 13 by changing the position of the support leg 19. This functionality provides convenience to a user wherein the support wall upon which the mountable table is mounted comprises a curved surface, an angled surface or a tapered surface.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A mountable table, comprising:
a board having a first end and a second end, the first end hingedly affixed to at least one first fastener;
the first fastener configured to removably secure the board to a support wall;
a support leg hingedly attached to a lower surface of the board;
the support leg having a second fastener disposed on an end thereof, opposite the board.

2) The mountable table of claim 1, wherein an upper surface of the board has a recess configured to receive a food or beverage container.

3) The mountable table of claim 2, further comprising a flat insert configured to rest in the recess.

4) The mountable table of claim 1, wherein the first fastener and the second fastener are suction cups.

5) The mountable table of claim 4, wherein the suction cups are lever-actuated suction cups.

6) The mountable table of claim 1, further comprising a bumper disposed on at least one side of the board.

7) The mountable table of claim 1, wherein the board is made of a material adapted to frictionally support to a plurality of objects on the upper surface thereof.

8) The mountable table of claim 1, wherein the support leg is centrally disposed between a pair of sides of the board.

9) The mountable table of claim 1, wherein the support leg is telescopic.
